(19) United States
(12) Patent Application Publication
(10) Pub. No.: US 2010/0065718 A1
(43) Pub. Date: Mar. 18, 2010

(54) HANS STREUBEL AND GEREON FEHLEMANN

(76) Inventors: Hans Streubel, Erkrath (DE); Gereon Fehlemann, Dusseldorf (DE)

Correspondence Address: FRIEDRICH KUEFFNER, 317 MADISON AVENUE, SUITE 910, NEW YORK, NY, 10017, US

(21) Appl. No.: 12/449,000

(22) PCT Filed: Dec. 13, 2007
(86) PCT No.: PCT/EP2007/010921

§ 371 Date: Aug. 28, 2009

(30) Foreign Application Priority Data
Jan. 18, 2007 (DE) 10 2007 002 806.9

(51) Int. Cl. B22C 9/08; B05D 1/08; B05D 1/10

(52) U.S. Cl. 249/105; 427/446

(57) ABSTRACT

The invention relates to a die (1) with a funnel-shaped pouring region (7) for casting molten metal, comprising a die wall (2, 3, 4, 5) with a hot side, which is in contact with the molten metal, and a coating (12) on the hot side. The thickness of the coating (12) is smaller in a transition region (10) from the funnel-shaped pouring region (7) to the lateral parallel regions (11) than in the pouring region (7) and in the parallel region (11). The invention further relates to a method for coating a die (1) of said kind.

The invention relates to a mold with a funnel-shaped pouring area for casting liquid metal; the mold has a mold wall with a hot side which is in contact with the liquid metal and a coating on the hot side.

The invention also relates to a method of coating such a mold.

Continuous casting molds are subjected to high temperature applications on the mold hot side and in particular in the area of the bath level area. In thin slab plants with casting speeds of up to 10 m/min, mold wall temperatures which are too high and changing on the hot side of the casting width this lead to a reduced service life of the mold. For increasing the service life, it is known in the art to coat, for example, with nickel, the entire surface area which comes into contact with the liquid metal. Due to the high temperature application, cracks occur in the coating and the coating falls off.

DE 100 03 827 A1 describes a method of manufacturing a mold of copper materials for continuous casting plants with a wear-resistant coating on the mold-forming surfaces which delimit the interior hollow space of the mold, wherein the wear-resistant layer is of at least one amorphous carbon layer.

Continuous casting molds for the continuous casting of steel or other metals with a coating or a reinforcement are described in DE 37 27 424 A1, DE 26 25 914 B2, DE 34 15 050 A1, DE 32 18 100 C2, DE 100 62 490 A1.

DE 40 39 230 C2 discloses a method of coating a continuous casting mold used in a continuous casting plant of a material having a hard surface, particularly for coating a mold for a slab/strip casting plant of up to 300 mm slab thickness or for a strip/strand casting plant of up to 60 mm strip thickness whose material consists of copper or a copper alloy, wherein the inner surfaces of the mold which guide the metal melt are coated from the pouring area to the discharge area and possibly transversely thereof in surface areas or surface segments in accordance with the loads which cause the wear and/or in accordance with the thermal conductivity capability and/or in accordance with the thermal expansion coefficient, wherein the surface-hard material is platinum which has been applied on the inner surfaces of the mold by means of explosive plating.

DE 44 02 046 A1 discloses a method of coating the surface of copper materials with a protective layer, wherein the copper material is provided with a cover layer. Subsequently, in the area of an application area, the protective layer is applied by supplying protective layer components and melting the components with laser radiation and are connected by providing essentially in the application surface area by melting the copper material.

DE 195 20 149 A1 describes a method and a plant for a thermal coating process for the manufacture of millimeter-high coatings on tools, structural components or substrates, in which an additional material is added to a substrate material and is melted by means of a laser beam in order to achieve a solidly adhering contact between the substrate and the additional material. In this process, in addition to the substrate a smooth-walled mold is used which together with the substrate supports the molten additional material on at least two sides, usually four sides, against running, wherein the additional material and the laser radiation are supplied through one or two of the remaining sides of the additional material and by a relative movement between the laser beam and the additional material, on the one hand, and the substrate, on the other hand, so as to create a smooth coating on the substrate which has a contour near the final contour.

Molds whose side walls have a coating are also known from JP 04 157 181, JP 08 013 134, JP 61 272 364, JP 09248 828, JP 10 030 154, and JP 05 104 536.

A method for producing a mold body with a wear protective layer is known from DE 197 56 164 A1, wherein the wear protective layer has a constant thickness in the casting direction. However, it is also possible that the thickness of the wear protective layer increases in casting direction. However, this influences the heat supply negatively.

Therefore, it is the task of the invention to provide a mold with a coating in which the mold wall temperature on the hot side is made uniform over the casting width, particularly in the area of the bath level, so that the surface quality is further improved and the mold service life is further increased and the mold costs per ton of steel are lowered.

In accordance with the invention, this task is solved in a mold with a coating according to the preamble of claim 1, the thickness of the coating in a transition area from the funnel-shaped pouring area to the parallel areas, the thickness of the coating is smaller than in the pouring area and the parallel area.

Further embodiments of the mold result from the respective dependent claims.

As a result of the thickness of the coating which becomes smaller in the transition area from the funnel to the lateral parallel areas, the temperature of the hot side of the mold is rendered uniform especially horizontally and the service quality of the cast strip is further improved and the surface life of the mold increased.

As a further development it is proposed that in the transition area from the funnel-shaped pouring area to the lateral parallel areas, the thickness of the coating is smaller than in the pouring area and in the parallel area. This causes the higher surface temperature as a result of the flow to become uniform in the transition area. With the same thickness of the coating, the transition area has a higher surface temperature. A uniform horizontal surface temperature distribution is a prerequisite for a fault-free strand surface.

It is further advantageous if the coating in the bath level area has a layer thickness of 2 to 30 μm and/or the coating is composed of at least two coating layers with different properties, such as very low thermal conductivity, very high adhesive capacity, thermal shock.

The coating can be applied with different methods, such as the flame injection which is applied in a differentiated manner in the wire flame spraying, among others for nickel coatings and the powder flame spraying, among others for ceramic layers.

It is also possible to apply this coating by means of the gas-stabilized plasma spray which is suitable, among others, for high-melting materials or ceramic materials, or the water-stabilized plasma spray which is used, among others, for thicker ceramic layers of up to 10 mm.

In addition, it is also possible to use the high speed flame spray method, which is suitable, among others, for spray materials with hard metal additional materials.

An embodiment of the invention will be described in more detail with the aid of schematic drawings.

In the drawing:

FIG. 1 shows in a top view the funnel-shaped pouring area of a mold;

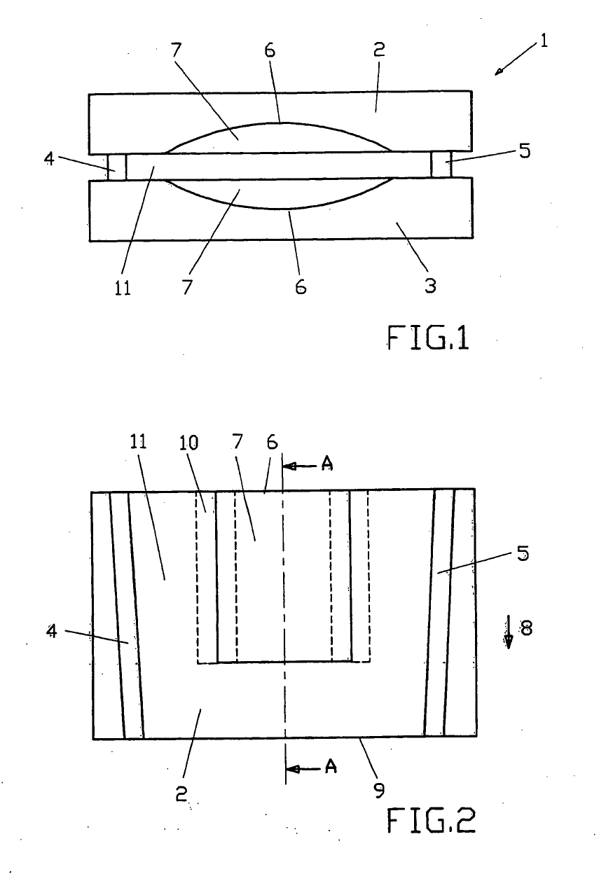

FIG. 2 shows a mold wall with pouring area having a rectangular funnel shape; and

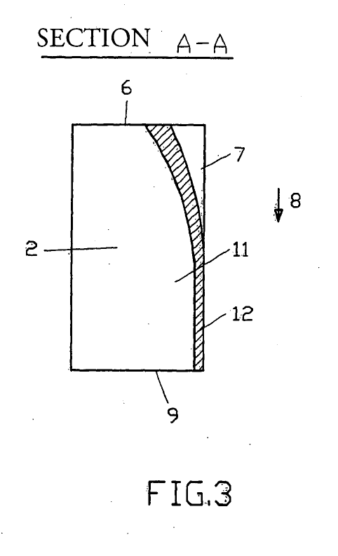

FIG. 3 is a sectional side view of a mold wall with coating.

As illustrated in FIG. 1, a mold 1 is composed of four mold walls 2, 3, 4, 5; for example, two oppositely located wide side walls 2, 3 and two narrow side walls 3, 4 arranged laterally between the wide side walls 2, 3. The wide side walls 2, 3 have a curved funnel-shaped pouring area 7 which begins at the upper edge 6 of the mold 1. At the narrow side 3, 4 and in the casting direction 8 (see FIG. 2) the pouring area is reduced to the size of the cast strand.

FIG. 2 shows a mold wall in a front view. The casting area 7 has the shape of a rectangle. Other shapes, such as trapezoids, parabolas, etc., are conceivable. The funnel-shaped pouring area 7 leads into a parallel area 11 and forms a transition area 10 as a result. The casting direction 8 extends from the mold upper edge 6 to the mold lower edge 9.

A coating 12 of the mold 1 is illustrated in a sectional side view in FIG. 3. The coating 12 is effected on the mold wall 2 at the surface which comes into contact with the hot metal.

### LIST OF REFERENCE NUMERALS

1 mold
2 wide side wall
3 wide side wall
4 narrow side wall
5 narrow side wall
6 mold upper edge
7 casting area
8 casting direction
9 mold lower edge
10 transition area
11 parallel area
12 coating

1. Mold (1) with funnel-shaped pouring area (7)
for casting liquid metal, having a mold wall (2, 3, 4, 5) which includes a hot side which is in contact with the liquid metal, and a coating (12) on the hot side, wherein in a transition area (10) from the funnel-shaped pouring area (7) to the lateral parallel areas (11), the thickness of the coating (12) in the horizontal direction is smaller than in the pouring area (7) and in the parallel area (11).

2. Mold (1) according to claim 1, in that wherein the coating (12) in the transition area (10) has a thickness of 50% to 80% of the thickness of the coating (12) of the pouring area (7) and the parallel area (11).

3. Mold (1) according to claim 1, wherein in the vertical casting direction (8), the thickness of the coating (12) decreases in the lower mold area to a thickness of 40% to 80% of the thickness of the coating (12) of the upper pouring area (7).

4. Mold (1) according to claim 1, wherein the thickness of the coating (12) in the bath level area has a layer thickness of 2 to 30 μm.

5. Mold (1) according to claim 1, wherein the thickness of the coating (12) is composed of at least two coating layers having different properties.

6. Mold (1) according to claim 1, wherein the coating (12) is composed of one or a combination of ceramic materials/compounds or ceramic additional spraying material, such as titanium oxide or chrome nitrate or zircon nitrate.

7. Mold (1) according to claim 1, wherein the coating (12) is composed of a hard metal material, such as nickel or a combination of different hard metal materials, among others, nickel, chromium.

8. Mold (1) according to claim 1, wherein the coating (12) is of titanium nitrate or chromium nitrate or zircon nitrate.

9. Method of coating a mold (1) according to claim 1, wherein the coating (12) is applied by means of a flame spray method, such as wire flame spraying or powder flame spraying.

10. Method of coating a mold (1) according to claim 1, wherein the coating (12) is applied by means of a gas or water stabilized plasma spraying method.

11. Method for coating a mold (1) according to claim 1, wherein the coating (12) is applied by means of a high speed flame spraying.
